(19) United States
(12) Patent Application Publication
(10) Pub. No.: US 2006/0192656 A1
(43) Pub. Date: Aug. 31, 2006

(54) Transmission of data to or from transponder devices

(75) Inventors: Robert John Castle, Bristol (GB); John Deryk Waters, Bath (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P.

(21) Appl. No.: 11/361,984

(22) Filed: Feb. 27, 2006

(30) Foreign Application Priority Data
Feb. 25, 2005 (GB) 0503845.0

(51) Int. Cl. H04Q 5/22

(52) U.S. Cl. 340/10.34; 340/10.1

(57) ABSTRACT

A transponder device comprises a transponder device clock having a transponder device clock frequency. The transponder device is operable to transmit a training bit sequence to a read-write device. The read-write device is able to calculate the transponder device clock frequency for the transponder device from the training bit sequence.

### FIELD OF THE INVENTION

The invention relates to a read/write device, a memory tag, a method of transmitting information and a method of operating a memory tag.

### BACKGROUND OF THE INVENTION

Transponders in the form of Radio Frequency Identification (RFID) tags are well known in the prior art. RFID tags come in many forms but all comprise an integrated circuit on which data can be stored and a coil which enables it to be interrogated by a reader which also powers it by means of an inductive (wireless) link. RFID tags have tended to be used in quite simple applications, such as for file tracking within offices or in place of or in addition to bar codes for produce identification and supply chain management, but improvements in memory capacity have enabled memory tags to receive, store and transmit greater amounts of data.

A known problem in any digital data transmission system is that of jitter. This is caused by a mismatch in the frequency of the transmitted data and the frequency at which the received data is sampled. Where the transmitter and receiver each have separate clocks operating at distinct frequencies, this can arouse from differences in the clock frequencies for example.

A number of techniques are known to obtain the clock frequency of the transmitter or the bit frequency of a transmitted data stream, referred to as clock recovery and timing recovery respectively. In general clock or timing recovery is required when the clock frequency of the transmitter is not made available to the receiver, for example through a master frequency signal supplied to both transmitter and receiver. To enable clock recovery from a transmitted data stream, it is known, for example, to encode the bit stream using a coding method that ensures regular transitions, such as Manchester coding. More sophisticated techniques are known, such as using timing recovery loop circuits or Schmitt trigger circuits to recover a clock frequency from the signal. It is also known to use circuits such as phase-locked loops to perform clock or timing recovery.

A memory tag comprises an electronic memory and has no integral power source—the simplest example is a conventional RFID tag. When writing data to a memory tag, the problem thus arises of correctly sampling the transmitted data stream. It is known to provide a clock recovery circuit using an injection locked oscillator on an RFID tag as described in “Wireless, remotely powered telemetry in 0.25 mm CMOS”, F Kocer et al, RFIC 2004, pp 339-342, but in general providing such active clock or timing recovery circuits on a memory tag imposes additional silicon area requirements on the memory tag integrated circuit.

### SUMMARY OF THE INVENTION

According to a first aspect of the invention there is provided a transponder device comprising a transponder device clock having a transponder device clock frequency, the transponder device being operable to transmit a training bit sequence to a read-write device such that the read-write device is able to calculate the transponder device clock frequency for the transponder device from the training bit sequence.

### BRIEF DESCRIPTION OF THE DRAWINGS

The invention will now be described by way of example only with reference to the accompanying drawings wherein:

FIG. 1 is a diagrammatic illustration of a read-write device and memory tag embodying the present invention,

FIG. 2 is a diagrammatic illustrating a method of transmitting data embodying the present invention,

FIG. 3 is an illustration of the Bresenham line algorithm, and

FIG. 4 is an illustration of an alternative method embodying the present invention.

### DETAILED DESCRIPTION OF EMBODIMENTS OF THE INVENTION

While generally applicable to transponder devices, aspects of the invention are particularly relevant to memory tag transponder devices. Embodiments described below all relate specifically to memory tags, though it will be noted that the principles described below may be applied equally to transponder devices not describable as memory tags.

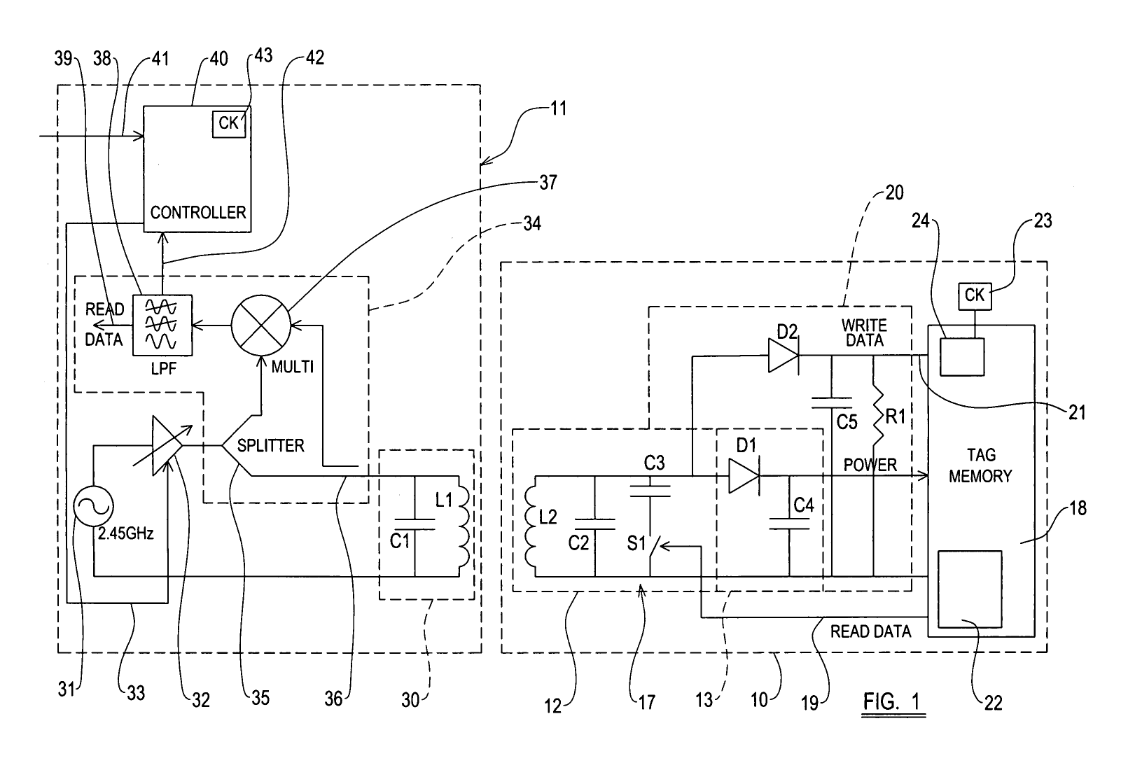

Referring now to FIG. 1, a memory tag embodying the present invention is shown at 10 and a read-write device shown at 11. In this description, a preferred form of ‘memory tag’ is used comprising a transponder device having a memory in which data is stored and where the transponder device is readable via and powered by a radio frequency wireless communication link, in the present example through inductive coupling. The term ‘memory tag’ may thus include, but is not limited to, read only RFID tags of known type and transponder devices with a memory which may be read from and written to. Aspects of the invention are however of particular value to memory tags adapted to store significant quantities of digital data—as opposed to the single reference datum typically stored by a conventional RFID tag—a type of which is described in detail below. The tag 10 comprises a resonant circuit part 12 and a rectifying circuit part 13, together with a memory 18. The resonant circuit part 12 comprises an inductor L2 and a capacitor C2 connected in parallel. The indicator L2 in this example comprises an antenna, and the resonant frequency part 12 will have a resonant frequency set by the inductor L2 and capacitor C2. The resonant circuit part 12 further comprises a controllable capacitive element generally indicated at 17, in the example of FIG. 1 comprising a capacitor C3 and a switch S1 which is connected to a read data line 19 connected to the memory 18 to modulate the resonant frequency of the resonant circuit part 12.

The rectifying part 13 comprises a diode D1 connected to the resonant circuit part 12 in a forward biased direction and a capacitor C4 connected in parallel with the components of the resonant circuit part 12. The rectifying circuit part 13 operates as a half-wave rectifier to provide power to the memory 18.

The tag 10 further comprises a write data circuit part 20. The write data circuit part 20 comprises a diode D2 connected in the forward bias direction to the output of the resonant circuit part 12, with a capacitor C5 and a resistor R1 connected in parallel with the components of the resonant circuit part 12. The write data circuit part 20 thus in this embodiment comprises a simple envelope detector which is responsive to the magnitude of the signal generated by the resonant circuit part 12, and provides a write data signal on a line 21 to the memory 18.

The read/write device 11 comprises a resonant circuit part 30 which comprises an inductor L1 and a capacitor C1 connected in parallel. A frequency generator 31 is connected to the resonant circuit part 30. The resonant circuit part 30 will have a resonant frequency, and the resonant frequencies of the resonant circuit parts 30, 12 are selected to be nominally the same. The read-write device 11 further comprises an amplitude modulator 32 which is controllable in response to data sent on a write data line 33. The amplitude modulator 32 controls the power of the signal from the frequency generator 31 to the resonant circuit part 30, and thus provides modulation of the amplitude of the power of the signal generated by the resonant circuit part 30 which can be detected by the write data circuit part 20 of the tag 10.

In use, when the memory tag 10 is sufficiently close to the conductor L1 of the read-write device 11, there will be inductive coupling between the resonant circuit parts 12, 30. The resonant circuit part 12 will draw power from the magnetic field of the inductor L1, and the resulting signal is rectified by the rectifying circuit part 17 to supply power to the memory 18. The rectifying circuit part 17 serves to smooth the voltage across the resonant circuit part 12, provide a power supply storage, and efficiently supply the appropriate voltage to the memory 18.

The read-write device 11 further comprises a demodulator, generally shown at 34. The demodulator 34 comprises a splitter 35 connected to the frequency generator 31 to split off a part of the signal to provide a reference signal. A coupler 36 is provided to split off a part of the reflected signal reflected back from the resonant circuit part 30. The reference signal and reflected signal are passed to a multiplier indicated at 37. The multiplier 37 multiplies the reflected signal and the reference signal and passes the output to a low pass filter 38. The low pass filter 38 passes a signal corresponding to the phase difference between the reference signal and the reflected signal to an output 39. By controlling the switch S1 of the tag 10 under control of the memory 18, the resonant frequency of the resonant circuit part 12 can be modulated and hence the phase of the reflected signal reflected by the resonant circuit part 30 with respect to the reference signal can be modulated. This change of phase is detected by the demodulator 34, and so data can be read from the tag 10 by the read-write device 11. By this method, data may be transmitted from the tag 11 whilst not significantly affecting the power drawn by the resonant circuit part 12.

To provide for reading and writing operation of the memory tag 10, a control program is shown generally illustrated at 22 on the memory tag 10. The memory tag is further provided with a transponder device clock, in this case a memory tag clock shown at 23 to provide a memory tag clock frequency to, for example, set the sampling rate at which the amplitude envelope on the write data line 21 is sampled by the program 22. Similarly, the memory tag clock frequency also sets the bit rate at which data is transmitted to the read-write device by the program 22 controlling switch S1 via the read data line 19. In this example, a clock controller 24 is also provided to re-synchronise the clock 23 in accordance with transitions in data received on line 21, though this may be omitted as appropriate. In the present example, the clock 23 has a memory tag clock frequency of about 10 MHz. In practice, such clocks are stable in that they show relatively little drift over the operating period during which they are used, but the actual frequency can be within ±30% of the nominal frequency.

The term “operating frequency” will be used in the following discussion to refer to the effective frequency of data transmission used by the memory tag—essentially the memory tag clock frequency. For a transponder device other than a memory tag, this would be the transponder device clock frequency. This is distinct from the frequency of the RF carrier wave. The carrier wave frequency and the operating frequency are not tied together in any way and are related only in that one frequency places gross physical constraints on the other (such as that data transmission cannot be carried out at a rate greater than the carrier wave frequency).

To permit data to be written to the memory tag 10 by the read-write device 11, an appropriate controller 40 is shown. The controller is supplied with data to be written, for example on a data in line as shown at 41, and in this example further receives the output from the demodulator 34 as shown by line 42. The controller 40 is operable to control the amplitude modulator 32 by line 33. The controller 40 further comprises a read-write device clock 43 which provides the read-write device operating frequency, in this example about 80 MHz. The controller 40 is operable to calculate an operating frequency of the memory tag 10 and transmit data to the memory tag 10 by controlling the amplitude modulator 33 at an appropriate corresponding bit frequency.

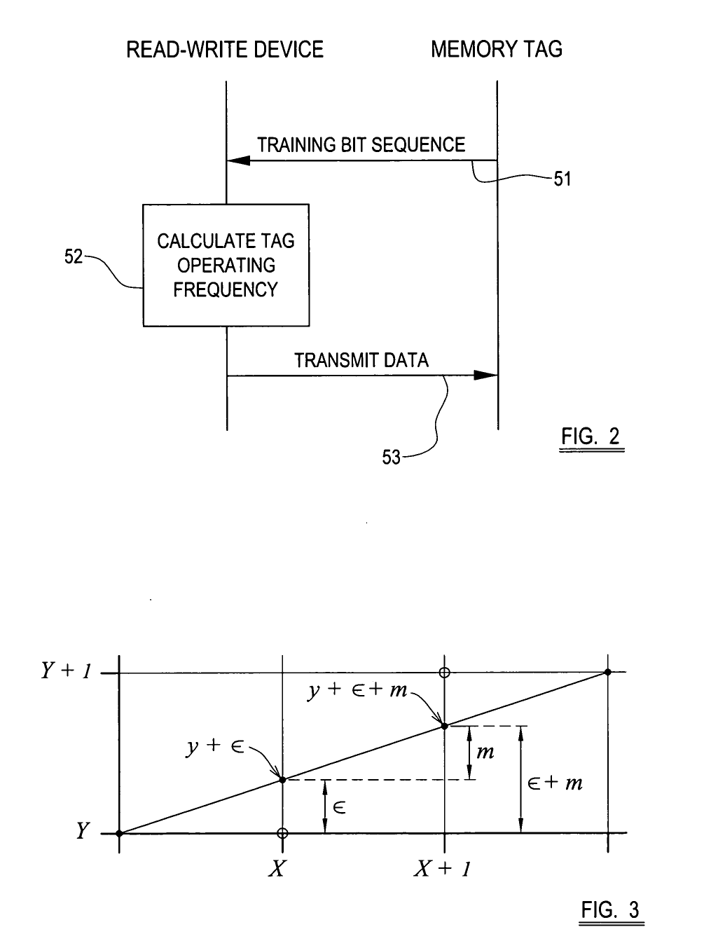

In a simple example of a method of writing data to a memory tag as shown in FIG. 2, at step 50 the memory tag is brought sufficiently close to the inductor L1 for power to be supplied to the memory 18 as discussed above. In response, the memory tag 10 transmits a training bit sequence as shown at 51. The training bit sequence consists of data encoded in such a way as to provide a regular series of transitions. For example, the training bit sequence may simply comprise the bit sequence 101010 . . . encoded as phase transitions which generate an output at 39 comprising simple amplitude levels. There will be a regular series of transitions between high and low amplitudes. In the present example, the sequence of bits will be at a frequency corresponding to the memory tag clock frequency set by memory tag clock 23, although they may of course be transmitted at an operating frequency which is lower than but derived from or dependent on this clock frequency. Alternatively, the training bits may be a series of bits encoded in a particular encoding scheme, such as Manchester coding which encodes each bit as a transition between high and low or vice versa. This ensures a series of regular transitions and advantageously enables some handshaking or initial data to be transmitted as part of the training bit sequence. It will be apparent that any other training bit sequence may be used as desired.

At step 51, the controller 40 calculates the tag operating frequency. This may be calculated by any appropriate means as desired. A simple approach is to count how many cycles of the read-write device clock 43 occur between a selected number of transitions in the training bit sequence, for example 16. This will give an average number of bits per clock cycle, and will thus indicate the operating frequency of the memory tag 10 relative to the read-write device clock frequency provided by the clock 43. The operating frequency of the memory tag 10 may thus be exactly calculated as a frequency value or may simply be calculated in terms of a number of clock cycles of the clock 43, or otherwise as desired. At step 53, the data to be written to the memory tag is transmitted by the read-write device 11 at or substantially at the operating frequency calculated at step 52. For example, if the transmission scheme is a simple encoding of a “1” bit as a high amplitude and a “0” as a low amplitude and it has been calculated that the clock 43 is operating at 80 MHz and the clock 23 operating at 10 MHz, each bit transmitted by the read-write device 11 will need to last for eight cycles of the clock 43 to ensure it is sampled by the program 22 in response to a cycle of the clock 23. To ensure that the program 22, does not sample the transmitted data at a bit edge the program 22 can adjust the phase of the clock 23. Alternatively, the read-write device may be operable to establish the phase of the clock 23 relative to the phase of the clock 43 and the amplitude modulator 22 is controlled by the controller 40 to ensure that a sample is taken by the tag 10 at or around the centre point of the relevant transmitted bit.

Although the above example has assumed clock frequencies of 10 MHz and 80 MHz for the memory tag 10 and read-write device 11 respectively, it is clear that in practice the frequency of the read-write device clock 43 is unlikely to be an exact multiple of the frequency of the memory tag clock 23. Thus, if each bit transmitted by the read-write device 11 consists of an non-integral number of cycles of the clock 43, the transmitted bits and the frequency at which they are sampled by the memory tag 10 will gradually cease to be synchronised. To overcome this, the controller 40 in the present example is operable to perform a compensation step, to vary the number of clock cycles in a given bit. This may be done by any appropriate method, but a computationally simple method uses the Bresenham line algorithm, originally intended to provide a computationally simple way of drawing a line on a raster grid. This is illustrated in FIG. 3, where a function y=mx but may only take discrete values shown at Y, Y+1. At X the correct value of y is Y+ε. To move from X to X+1, the value of y increases to by an amount equal to the gradient of the line m, resulting in a value of Y+ε+m. The approximate value selected for y is chosen in the basis of the inequality Y+ε+m<Y+0.5.

If this inequality is true, then the value Y will be selected, otherwise the value Y+1 will be selected. The error from this new point can now be written back into ε and the process can be repeated for the next point X at X+2. This algorithm can be rewritten in an integer-only form to avoid the use of floating-point arithmetic.

This algorithm may be applied to selecting the number of clock cycles in each bit transmitted by the read-write device using the formula y=Nx, where y is the number of transmitted bits, N is the number of bits per clock cycle calculated at step 52, and x is the number of clock cycles. N will probably be a non-integer number, whilst y will only be able to take integer values Y, Y+1, Y+2 etc corresponding to the number of complete transmitted bits. By using the Bresenham line algorithm,. the number of clock cycles for a given bit can thus be easily calculated, and the transmitted data stream will overall have the correct average number of clock cycles per bit.

In an alternative embodiment, the controller 40 may comprise a fractional-N frequency synthesiser to ensure that the transmitted data stream has the average number clock cycle per bit. Fractional-N frequency synthesisers generate an output signal having a required frequency by dividing a reference frequency by a selected modulus to generate the desired output. The divider modulus can be controlled using a counter such that the effective divider modulus is the product of the set counter value and the set divider modulus. As both the set divider modulus and the counter value are integral, this limits the available output frequencies and so it is known to use fractional-N frequency synthesisers to generate output frequencies which are non-integral multiples of the reference frequency. In a fractional-N frequency synthesiser, the divider modulus is switched between values N and N+1 to provide the desired overall average output frequency.

It will be apparent that this is effectively the same process as used in the Bresenham line algorithm as discussed above, and effectively will switch each bit length between n and n+1 clock cycles to produce the correct overall average number of clock cycles per bit. As in the embodiment above, the controller 40 will calculate the number of clock cycles per bit (in effect the ratio between the read-write device clock frequency provided by the clock 43 and the tag operating frequency) and vary the divider modulus between appropriate values of N and N+1 to effectively synthesise an output frequency which on average will match the operating frequency of the memory tag 10. Using a fractional-N frequency synthesiser instead of the Bresenham line algorithm calculation discussed above may be appropriate for those read-write devices that do not have sufficient computational bandwidth to perform the Bresenham line algorithm.

In each of these embodiments, it will be clear that over any given part of the transmitted data, the frequency at which data is written to the memory tag 10 will be substantially at the calculated operating frequency of the memory tag 10. The error in the transmission frequency of a given group of bits and the calculated time of operating frequency should be within the equivalent of half a clock cycle of the read-write device clock 43.

It will be apparent that if it is only desired to read the data from the memory tag, then control of the transmitted data frequency will not be required. Further, as discussed above, once the controller 40 has calculated the operating frequency of the memory tag 10, then the read-write device essentially free runs, that is transmits data at the calculated operating frequency without continually checked or recalculating the quality frequency.

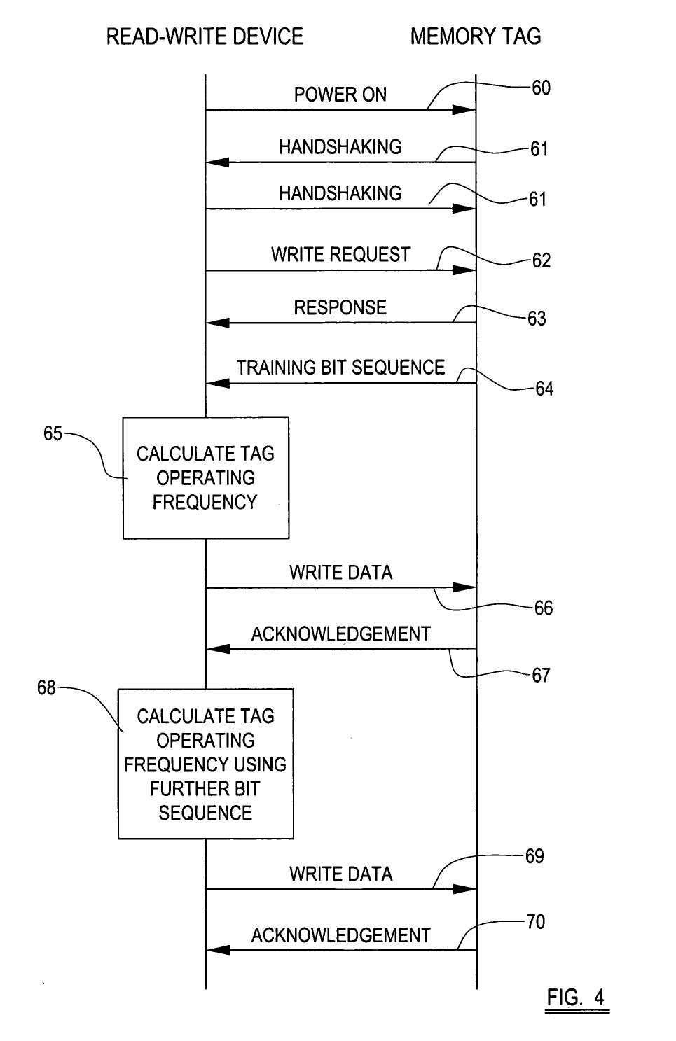

To address these issues, the method of FIG. 2 may be adapted as it shown in FIG. 4. Referring to FIG. 4, the memory tag 10 is brought within range of the inductor L1 and supplied with power. In this example, handshaking steps are performed at 61 to supply appropriate information, such as security data, memory tag capacity, identifiers or other such information. The messages transmitted at 61 are encoded to ensure that regular transitions are provided and so there is no requirement to calculate an operating frequency at this stage. At step 62, the read-write device 11 transmits a write request to the memory tag 10 which at step 63 transmits a response, such as OK, capacity available, writing not permitted, etc. If writing to the memory tag is to be permitted, then at step 64 a training bit sequence as discussed above is transmitted. It will be apparent that, with suitable encoding, the response 63 may itself further be or include the training bit sequence 64. At step 65, the read-write device 10 calculates the memory tag operating frequency as in step 52 of FIG. 2, and at step 66 transmits the data to be written to the memory tag 10. At step 67, the memory tag 10 transmits an acknowledgement.

It will be apparent that, if appropriately encoded, this acknowledgement may serve as or include a further training bit sequence, and at step 68 the tag operating frequency may be calculated using the further training bit sequence. Successive data writing step 69 and acknowledgement step 70 may follow in like manner to the steps 66 and 67. This will allow the read-write device 11 to accommodate any drift or change in the memory tag clock frequency generated by the memory tag clock 23. The acknowledgement 67 may also include some form of error control such as CRC checking. The controller may also use bit sequences other than training bit sequences to check the calculated operating frequency.

The operation of the read-write device 11 and memory tag 10 thus allows data transmission to occur from the read-write device 11 to the memory tag 10 whilst minimising jitter and maximising the transmitted data rate. By not using Manchester coding, the 50% data transmission penalty that coding method imposes is avoided. In effect the transmitter adjusts its transmission frequency to match that of the receiver, in a reversal of the conventional manner. The recovery of the transmission frequency can be done in a computationally simple manner, and does not impose any large additional demands on the resources of the memory tag 10.

In the present specification “comprise” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A read-write device for reading data from and transmitting data to a transponder device, the read-write device being operable to;
receive a training bit sequence from a transponder device,
calculate a transponder device clock frequency from the training bit sequence, and
transmit data to the transponder device substantially at the transponder device clock frequency.

2. A read-write device according to claim 1 wherein the training bit sequence comprises data encoded to provide a plurality of regular transitions and wherein the read-write device is operable to detect the transitions and calculate the transponder device clock frequency accordingly.

3. A read-write device according to claim 2 comprising a reader clock having a reader clock frequency, wherein the step of calculating the transponder device clock frequency comprises counting the number of clock cycles of the reader clock between successive transitions.

4. A read-write device according to claim 3 wherein the step of transmitting data to the transponder device in accordance with the transponder device clock frequency, comprises transmitting the data with a bit length corresponding to the number of reader clock cycles.

5. A read-write device according to claim 4 operable to perform a compensation step to vary the bit length to maintain synchronisation between the transponder device clock frequency and the frequency of the transmitted bits.

6. A read-write device according to claim 5 wherein the compensation step comprises calculating the bit length in accordance with the Bresenham line algorithm.

7. A read-write device according to claim 1 wherein the transponder device comprises a memory tag clock having a memory tag clock frequency and where the calculated transponder device clock frequency is the memory tag clock frequency.

8. A read-write device according to any claim 1 operable to perform an initialisation stage, transmit a write request to the transponder device, and receive the training sequence from the memory tag in response to the write request.

9. A read-write device according to claim 1 operable to receive a subsequent message from the transponder device comprising a further bit sequence and calculate the operating frequency in accordance with the further bit sequence.

10. A read-write device according to claim 9 wherein the subsequent message transmitted by the transponder device comprises an acknowledgement of received data.

11. A transponder device comprising a transponder device clock having a transponder device clock frequency, the transponder device being operable to transmit a training bit sequence to a read-write device such that the read-write device is able to calculate the transponder device clock frequency for the transponder device from the training bit sequence.

12. A transponder device according to claim 11 operable to transmit the training bit sequence in response to a write request received from the read-write device.

13. A transponder device according to claim 11 operable to receive data from the read-write device and transmit a subsequent message comprising an acknowledgement of the data, the subsequent message comprising a further bit sequence such that the read-write device can calculate the transponder device clock frequency from the further bit sequence.

14. A transponder device according to claim 11 wherein the transponder device has a memory tag having a memory tag clock frequency and wherein the transponder device clock frequency is the memory tag clock frequency.

15. A method of transmitting data to a transponder device comprising the steps of;
receiving a training bit sequence from a transponder device,
calculating a transponder device clock frequency from the training bit sequence, and
transmitting data to the transponder device in substantially at the transponder device clock frequency.

16. A method according to claim 15 wherein the training bit sequence comprises data encoded to provide a plurality of regular transitions, the method comprising the steps of detecting the transitions and calculating the transponder device clock frequency accordingly.

17. A method according to claim 16 comprising the steps of receiving a reader clock signal having a reader clock frequency, and calculating the transponder device clock frequency by counting the number of clock cycles of the reader clock between successive transitions.

18. A method according to claim 15 wherein the step of transmitting data to the transponder device substantially at the transponder device clock frequency comprises transmitting the data with a bit length corresponding to the number of reader clock cycles.

19. A method according to claim 18 operable comprising the step of performing a compensation step to vary the bit length to maintain synchronisation between the transponder device clock frequency and the frequency of transmitted bits.

20. A method according to claim 19, wherein the compensation step comprises calculating the bit length in accordance with the Bresenham line algorithm.

21. A method according to claim 15 comprising the steps of performing an initialisation stage, transmitting a write request to the transponder device, and receiving the training sequence from the transponder device in response to the write request.
